(19) United States
(12) Patent Application Publication
(10) Pub. No.: US 2014/0195941 A1
(43) Pub. Date: Jul. 10, 2014

(54) MANAGING DISPLAY ON A COMPUTING SYSTEM

(71) Applicant: INTERNATIONAL BUSINESS MACHINES CORPORATION, Armonk, NY (US)

(72) Inventors: Nathan V. Bak, Portland, OR (US); Avantika R. Mathur, Tigard, OR (US); Eric B. Munson, Hillsboro, OR (US); Ramachandra N. Pai, Beaverton, OR (US); Timothy C. Pepper, Tigard, OR (US)

(73) Assignee: INTERNATIONAL BUSINESS MACHINES CORPORATION, Armonk, NY (US)

(21) Appl. No.: 13/738,922

(22) Filed: Jan. 10, 2013

(51) Int. Cl. G06F 3/0484

(52) U.S. Cl. CPC G06F 3/0484
USPC 715/766

(57) ABSTRACT

A system and a computer program product displays information associated with one or more desired contexts on a computing system. The disclosure enables defining of the one or more desired contexts. One or more active applications on the computing system are tracked and filtered based upon the one or more desired contexts. Information associated with the one or more desired contexts is displayed, and information not associated with the one or more desired contexts is concealed.

### FIELD OF THE INVENTION

The present invention relates to computing systems and associated display environments. More particularly, the present invention relates to a method, a system and a computer program product for displaying only desired information.

### BACKGROUND

Today, workers are increasingly required to “multi-task”, i.e., to undertake different types of work activities at the same time. When these multiple work activities are practiced simultaneously, distractions from one work activity spill over into another work activity automatically. Further, disruptions like emails, pop-ups, instant messages, etc., originate automatically and make it difficult for the user to focus on any work activity for a substantial amount of time or even allocate a dedicated amount of time on a particular work activity.

While, sometimes these emails, pop-ups and instant messages may be important for those who initiate them, but may not be highly optimal for the user being distracted. Therefore, attempts have been made to provide a user with a solution that offers a distraction-free, an organized work regimen.

For example, management tools have been developed that seek to help multi-tasking users to manage resources that they create and access while carrying out their work activities. These tools for example associate a set of files, folders, email messages, contacts, web pages that a user accesses while performing a particular work activity and when the user resumes the particular work activity, these tools can help the users regain cognitive context they held prior to switching away from the particular work activity. However, it does not provide much in terms of blocking unnecessary interruptions.

Other solutions enable the user to stay uninterrupted during specific occasions like meeting or presentations by suppressing all other information and displaying them when the specific occasion has been completed.

In light of the above discussion, it would be desirable to provide a management system and method that enables a user to optimize his work activities as per the user's requirements and at the same time improve productivity and efficiency of the user in managing the multiple work activities.

### BRIEF SUMMARY

The present disclosure involves providing a method, a system and a computer program product that enables display of information associated with a context desired by a user and concealment of all other information not associated with the context desired by the user.

The present disclosure also involves providing a method, a system and a computer program product that enables a user to manage multiple work activities in such a way that it improves overall productivity, efficiency and concentration of the user.

In an embodiment of the present disclosure, a method for displaying information associated with one or more desired contexts on a computing system has been provided. The method includes a step of a user defining the one or more desired contexts, such that the one or more desired contexts include at least a first set of rules. Thereafter the method includes the step of supplying the one or more desired contexts to one or more active applications on the computing system. Finally the method includes the step of enabling the one or more active applications to display the information associated with the one or more desired contexts and concealing information not associated with the one or more desired contexts.

In another embodiment of the present disclosure, a display manager enabled to display information associated with one or more desired contexts, on a computing system is provided. The display manager includes a memory configured to store the one or more desired contexts, such that the one or more desired contexts include at least a first set of rules defined by the user. The display manager also includes one or more processing units that are operatively coupled with the memory and are configured to supply the one or more desired contexts to one or more active applications on the computing system. The one or more processing units also enable the one or more active applications to display the information associated with the one or more desired contexts and conceal information not associated with the one or more desired contexts.

In yet another embodiment of the present disclosure, a computer program product is provided. The computer program product including instructions for displaying information associated with one or more desired contexts on a computing system. The computer program product including instructions for a user to define the one or more desired contexts, such that the one or more desired contexts include at least a first set of rules. Thereafter other instructions include supplying the one or more desired contexts to one or more active applications on the computing system. The computer program product also including instructions for enabling the one or more active applications to display the information associated with the one or more desired contexts and concealing information not associated with the one or more desired contexts.

Other embodiments and aspects of the disclosure are described in detail herein and are considered a part of the claimed invention. For a better understanding of the invention with advantages and features, refer to the description and to the drawings.

### BRIEF DESCRIPTION OF THE SEVERAL VIEWS OF THE DRAWINGS

The features of the present disclosure, which are believed to be novel, are set forth with particularity in the appended claims. The invention may best be understood by reference to the following description, taken in conjunction with the accompanying drawings. These drawings and the associated description are provided to illustrate some embodiments of the disclosure, and not to limit the scope of the disclosure.

FIG. 1 is a schematic block diagram depicting a display manager, in accordance with an embodiment of the present disclosure; and

FIG. 2 is a flowchart depicting a method of displaying information associated with a desired context, in accordance with an embodiment of the present disclosure.

Those with ordinary skill in the art will appreciate that the elements in the figures are illustrated for simplicity and clarity and are not necessarily drawn to scale. For example, the dimensions of some of the elements in the figures may be exaggerated, relative to other elements, in order to improve the understanding of the present disclosure.

There may be additional structures described in the foregoing application that are not depicted on one of the described drawings. In the event such a structure is described, but not depicted in a drawing, the absence of such a drawing should not be considered as an omission of such design from the specification.

### DETAILED DESCRIPTION

Before describing the present disclosure in detail, it should be observed that the present disclosure utilizes apparatus components and method steps related to a display manager and its associated functions. Accordingly the apparatus components have been represented where appropriate by conventional symbols in the drawings, showing only specific details that are pertinent for an understanding of the present disclosure so as not to obscure the disclosure with details that will be readily apparent to those with ordinary skill in the art having the benefit of the description herein.

Also, it should be observed that the present disclosure utilizes a combination of method steps and system components related to computer-implemented method for displaying information associated with one or more desired contexts. Accordingly, it will be appreciated that embodiments of the disclosure described herein may include one or more conventional processors and unique stored program instructions that control the one or more processing units to implement, in conjunction with certain non-processor circuits, some, most, or all of the functions of the method of displaying information associated with one or more desired contexts. The non-processor circuits may include, but are not limited to, a radio receiver, a radio transmitter, signal drivers, clock circuits, power source circuits, and user input devices. As such, these functions may be interpreted as steps of a method to perform the display. Methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

As required, detailed embodiments of the present disclosure are disclosed herein; however, it is to be understood that the disclosed embodiments are merely exemplary of the disclosure, which can be embodied in various forms. Therefore, specific structural and functional details disclosed herein are not to be interpreted as limiting, but merely as a basis for the claims and as a representative basis for teaching one skilled in the art to variously employ the present disclosure in virtually any appropriately detailed structure. Further, the terms and phrases used herein are not intended to be limiting but rather to provide an understandable description of the disclosure.

The terms “a” or “an”, as used herein, are defined as one or more than one. The term “another”, as used herein, is defined as at least a second or more. The terms “including” and/or “having” as used herein, are defined as comprising (i.e. open transition). The term “coupled” or “operatively coupled” as used herein, is defined as connected, although not necessarily directly, and not necessarily mechanically.

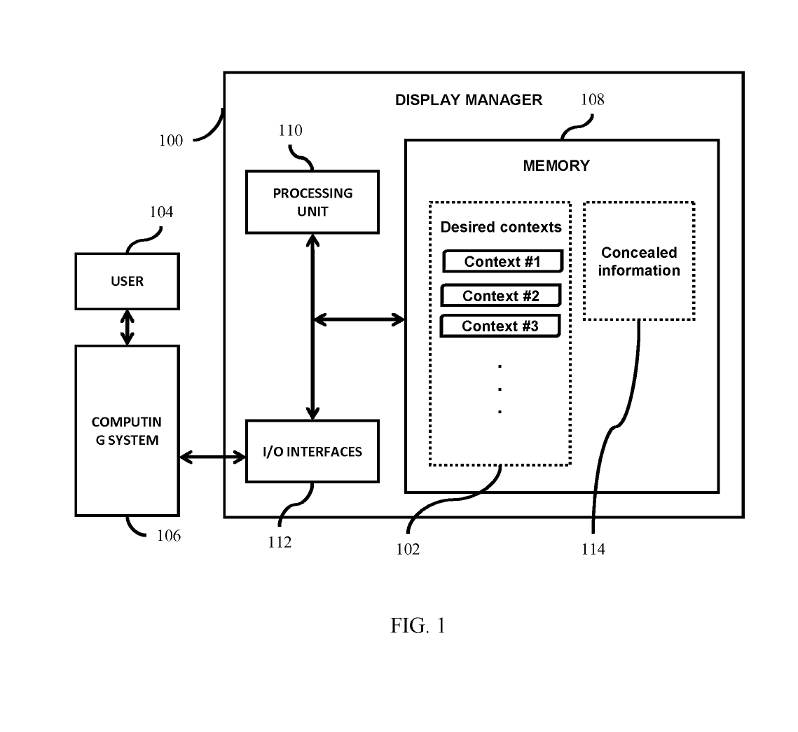

Referring now to FIG. 1, there is provided a schematic block diagram depicting a display manager 100 that enables display of information associated with one or more desired contexts 102 as defined by a user 104 on the user's computing system 106, in accordance with an embodiment of the present disclosure. In accordance with another embodiment of the present disclosure, the display manager 100 also functions to conceal, or override, information not associated with the one or more desired contexts 102 from the user 104.

The one or more desired contexts 102 may be described as an environment and/or a work activity of the user 104 and/or the computing system 106. The one or more desired contexts 102 are defined such that they include at least a first set of rules predefined as per the user's requirements. Each of the one or more desired contexts 102 have a corresponding set of rules defined by the user 104 as per requirements. The at least first set of rules can include policies defined by the user 104 on how to manage specific situations occurring on the computing system 106. The at least first set of rules may be based on a set of data that provides any information relating to the environment of the user 104 and/or the computing system 106. That information may include conditions, background, internal features of the computing system 106, applications, operating systems, components, network devices, location, and services such as internet/intranet. It may also include settings and activity of the user 104 and/or the computing system 106, interaction between the user 104 and the computing system 106, and internal operations of the computing system 106. For example, the user 104 may set a rule to display only information containing with a list of keywords or from a particular email id to be defined as the one or more context 102.

The user 104 may instruct the display manager 100 to manage the computing system 106 and operations on the computing system 106 based on the one or more desired contexts 102 selected by the user 104 at a point of time. The display manager 100 will then ensure that only the information associated with the one or more desired contexts 102 selected by the user 104 is displayed on the computing system 106 and the information not associated with one or more desired contexts 102 is concealed from the user 104.

In another embodiment of the present disclosure, a priority order may also be provided to the one or more desired contexts 102 selected by the user 104. For example, a first desired context may be given a higher priority in comparison to a second desired context. In this example, if any situation corresponding to the higher priority first desired context is observed, then the display manager 100 will ensure that information associated with the higher priority first desired context will not be concealed even if the user has selected the second desired context to be active at a particular point of time. The system can also display information from a lower context, if that lower context is also set by the user.

In another embodiment of the present disclosure, the user 104 may define one of the one or more desired contexts 102 as a context that includes an unconditional rule, the unconditional rule enabling display of all information. In yet another embodiment, the user 104 may be enabled to switch between the one or more desired contexts 102 at any arbitrary point of time depending upon requirements. Further, in another embodiment, the user 104 is further enabled to edit the at least first set of rules defining the one or more desired contexts 102 at any arbitrary point of time. In yet another embodiment, the user 104 may define one desired context of the one or more desired contexts 102 to include a union of a plurality of desired contexts. In an example, the user 104 may define the desired context to include two desired contexts. This union of two desired contexts will enable the display of all information associated with the two desired contexts.

Moving on, the display manager 100 is also shown to include a memory 108, one or more processing units 110 operatively coupled to the memory 108 and input/output (I/O) interfaces 112.

The memory 108 can be used to store information that can include the one or more desired contexts 102, listing of information associated with the one or more desired contexts, different set of rules defined by the user 104, listing of information not associated with the one or more desired contexts etc. In an embodiment, the memory 108 can also store a list of concealed information 114. Examples of the memory 108 can include, but are not limited to, magnetic or optical disk, flash memory, random access memory (RAM), read-only memory (ROM), or any other storage mediums that support storage of data for an arbitrary period of time (e.g., until deleted by a user). In an embodiment, the memory 108 can reside at a single physical location, or be distributed across as a plurality of physical systems in various forms.

Moving on, the one or more processing units 110 may be implemented in the form of one or more suitably configured microprocessors or microcontrollers. However, it should be appreciated that other implementations are also possible. In addition, the one or more processing units 110 may be in the form of a single processor, or may be distributed across as a plurality of processing units at one or more locations. In an embodiment, the one or more processing units 110 are configured to display information associated with the one or more desired contexts 102 on the computing system 106 of the user 104. The one or more processing units 110 can access the one or more desired context 102 stored in the memory 108. Thereafter, the one or more processing units 110 supply the one or more desired contexts 102 to one or more active applications on the computing system 106. An active application may be defined as any application that has been activated by the user 104 for providing a service to the user 104. In an embodiment the one or more processing units 110 may further determine an activity being performed by the user 104.

Based on the one or more desired contexts 102 and information available in the one or more active applications corresponding to the one or more desired context 102, the one or more processing units 110 will enable the one or more active applications to display the information associated with the one or more desired contexts 102 and concealing information not associated with the one or more desired contexts 102.

In an embodiment, examples of the one or more active applications can include, but are not limited to a web browser, an email client, business applications, executable files, and other software applications on the computing system 106.

In addition the display manager 100 also includes the input/output (I/O) interface(s) 112 that may be deployed with the display manager 100 and may include any interface capable of exchanging information with the user 104, for example information related to the one or more desired contexts 102.

Further, examples of the computing system 106 include, but are not limited to, computers, desktops, laptops, smart phones, tablet computers, wearable PCs, e-book readers, personal digital assistants (PDAs), and the like. Further, the present disclosure is designed to work on any operating system, including, but not limited to, Windows™ from Microsoft Corporation, iOS™ from Apple, Linux, Android™ from Google, and the like.

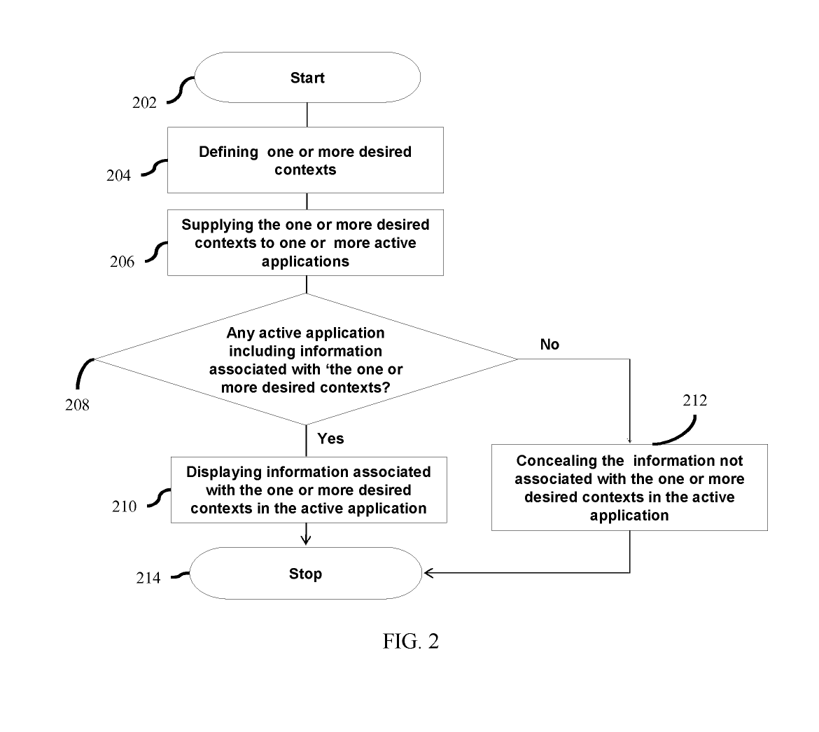

Moving on, FIG. 2 depicts a flow diagram depicting a method 200 of displaying information associated with one or more desired contexts, in accordance with an embodiment of the present disclosure. For the purpose of this description, the method 200 is explained in conjunction with the display manager 100 and its various components. However, it will be readily apparent to those ordinarily skilled in the art that the method 200 can also be applied, without deviating from the scope of the disclosure, for any other display management systems. Moreover, the disclosure is not limited to the order in which the steps are listed in the method 200. In addition, the method 200 can contain a greater or fewer numbers of steps than those shown in FIG. 2.

The method 200 is initiated at step 202. At step 204, a user, for example the user 104 may define one or more desired contexts, for example the one or more desired contexts 102, as per the user's requirements. The one or more desired contexts 102 may be defined to include the at least first set of rules predefined as per the user's requirements. The at least first set of rules including policies defined by the user 104 on how to manage specific situations occurring on the computing system 106.

Thereafter, at step 206, the one or more desired contexts is supplied to one or more of active applications on a computing system, for example the one or more active applications on the computing system 106.

Thereafter at step 208, each of the one or more active applications are checked to see if they include any information associated with the one or more desired contexts 102. In an embodiment, the one or more applications may be tracked and subsequently filtered. For each active application, it is determined whether the application includes information associated with the one or more desired contexts 102. If any application is found to be associated with the one and more desired contexts 102, the application is enabled to display the information associated with the one or more desired contexts 102 at step 210. If any information on any application is found not to be associated with the one or more desired contexts 102, the information associated not associated with the one or more desired contexts 102 is concealed at step 212.

For example, in an embodiment, user 104 has defined the one or more context to include a first set of keywords and email communications with a specific email id. The method 200 will check for presence of the first set of keywords on all active applications. For example, the method 200 identifies a web browser to contain two tabs containing information associated with the first set of keywords. The method 200 will in such a case, enable the web browser to only display the two tabs and conceal all other open tabs from the user 104. Similarly, if the method 200 identifies an email client to contain 25 emails containing information associated with the first set of keywords and associated with the specific email id, then the method 200 will in such a case, enable the email client to only display the 25 emails and conceal all other email communications.

Thereafter the method 200 is terminated at step 214.

In an embodiment of the present disclosure, the method 200 may include a step of setting up a priority order for the one or more desired contexts 102 selected by the user 104. For example, a first desired context may be given a higher priority in comparison to a second desired context. In this example, if any situation corresponding to the higher priority first desired context is observed, then the method 200 will ensure that information associated with the higher priority first desired context will not be concealed even if the user has selected the second desired context to be active at a particular point of time.

In another embodiment of the present disclosure, the method 200 may include step where the user 104 may define one of the one or more desired contexts 102 as a context that includes an unconditional rule, the unconditional rule enabling display of all information. In yet another embodiment, the user 104 may be enabled to switch between the one or more desired contexts 102 at any arbitrary point of time depending upon requirements. Further, in another embodiment, the user 104 may be further enabled to edit the one or more desired contexts 102 at any arbitrary point of time. In yet another embodiment, the method 200 may include a step where the user 104 may define one desired context of the one or more desired contexts 102 to include a union of a plurality of desired contexts. In an example, the user 104 may define the desired context to include two desired contexts. This union of two desired contexts will enable the display of all information associated with the two desired contexts.

The disclosure also provides a computer program product that includes instructions that enables the execution of a method described as per the disclosure, for example the method 200. For example, the method may be carried out using instructions of the computer program product executing on one or more suitably configured microprocessors or microcontrollers.

In an embodiment, the computer program product may incorporate various features of the present disclosure and be encoded on various computer readable storage media, suitable media include magnetic disk or tape, optical storage media such as compact disk or DVD (digital versatile disk), flash memory, and the like. Computer readable media encoded with the program code may be packaged with a compatible device or provided separately from other devices. Program code may also be encoded and transmitted using carrier signals (e.g, via Internet download) adapted for transmission via wired, optical, and/or wireless networks conforming to a variety of protocols, including the Internet.

While the disclosure has been disclosed in connection with the preferred embodiments shown and described in detail, various modifications and improvements thereon will become readily apparent to those skilled in the art. Accordingly, the spirit and scope of the present disclosure is not to be limited by the foregoing examples, but is to be understood in the broadest sense allowable by law.

All documents referenced herein are hereby incorporated by reference.

1-10. (canceled)

11. A display manager enabled to display information associated with one or more desired contexts, on a computing system of the user, the display manager comprising:
a memory configured to storing the one or more desired contexts, the one or more desired contexts comprising at least a first set of rules defined by the user; and
one or more processing units operatively coupled with the memory and configured to:
supplying the one or more desired contexts to one or more active applications on the computing system of the user; and
enabling the one or more active applications to display the information associated with the one or more desired contexts and conceal information not associated with the one or more desired contexts.

12. The display manager according to claim 11, wherein the one or more processing units is further configured to determine an activity being performed by the user.

13. The display manager according to claim 11, wherein one or more processing units is further configured to maintaining a list of the concealed information not associated with the one or more desired contexts and storing it in the memory.

14. The display manager according to claim 11, wherein the one or more processing units is further configured to enabling the user to switch between the one or more desired contexts.

15. The display manager according to claim 11, wherein the one or more processing units is further configured to enabling the user to edit the at least first set of rules.

16. The display manager according to claim 11, wherein the one or more active application is at least one of a web browser, an email client, business applications, executable files, and other software applications on the computing systems.

17. The display manager according to claim 11, wherein the one or more processing units is further configured to assigning a priority order to the one or more desired contexts.

18. The display manager according to claim 17, wherein information associated with a higher priority desired context is displayed overriding information associated with a lower priority desired context.

19. The display manager according to claim 11, wherein one desired context of the one or more desired contexts comprises a union of a plurality of desired contexts, the union of the plurality of desired contexts enabling display of all information associated with the plurality of desired contexts.

20. The display manager according to claim 11, wherein one desired context of the one or more desired contexts comprises an unconditional rule, the unconditional rule enabling display of all information.

21. A computer program product comprising computer readable medium, the computer readable medium comprising a program code used by a processor for execution on a computing system, with a purpose of displaying information associated with one or more desired contexts, the computer program product comprising instructions for:
defining the one or more desired contexts, the one or more desired contexts comprising at least a first set of rules defined by the user;
supplying the one or more desired contexts to one or more active applications on the computing system of the user; and
enabling the one or more active applications to display the information associated with the one or more desired contexts and concealing information not associated with the one or more desired contexts.

22. The computer program product according to claim 21 further comprising instructions for determining an activity being performed by the user.

23. The computer program product according to claim 21 further comprising instructions for maintaining a list of the concealed information not associated with the one or more desired contexts.

24. The computer program product according to claim 21 further comprising instructions for enabling the user to switch between the one or more desired contexts.

25. The computer program product according to claim 21 further comprising instructions for enabling the user to edit the at least first set of rules.
